(19) United States
(12) Patent Application Publication
(10) Pub. No.: US 2026/0072985 A1
(43) Pub. Date: Mar. 12, 2026

(54) INTERACTION METHOD, DEVICE, AND STORAGE MEDIA

(71) Applicants: Beijing Zitiao Network Technology Co., Ltd., Beijing (CN); Lemon Inc., Grand Cayman (KY)

(72) Inventors: Shuting Chu, Beijing (CN); Mengyin Lu, Culver City, CA (US); Daming Lu, Culver City, CA (US)

(21) Appl. No.: 18/883,793

(22) Filed: Sep. 12, 2024

(51) Int. Cl. G06F 16/78; G06F 16/58; G06F 16/783

(52) U.S. Cl. CPC G06F 16/7867; G06F 16/5866; G06F 16/7837

(57) ABSTRACT

Embodiments of the present disclosure provide a solution for interaction. A method comprises: displaying a post interface of a media content; displaying a set of candidate tags in the post interface, the set of candidate tags being determined based on post information inputted through the post interface; and based on a selection of a target tag among the set of candidate tags, determining a target element corresponding to the selected target tag, the target element being configured to be displayed in a review page of the posted media content.

### FIELD

The disclosed example embodiments relate generally to the field of computer science, particularly to an interaction method, device, and storage medium.

### BACKGROUND

With the rapid development of computer technology, the internet has now become an important platform for sharing various types of content items. Adding a tag to a content item to be posted may enhance user navigation and content retrieval within platforms.

### SUMMARY

In a first aspect of the present disclosure, there is provided an interaction method. The method comprises: displaying a post interface of a media content; displaying a set of candidate tags in the post interface, the set of candidate tags being determined based on post information inputted through the post interface; and based on a selection of a target tag among the set of candidate tags, determining a target element corresponding to the selected target tag, the target element being configured to be displayed in a review page of the posted media content.

In a second aspect of the present disclosure, there is provided an electronic device. The device comprises at least one processing unit; and at least one memory coupled to the at least one processing unit and storing instructions executable by the at least one processing unit, the instructions, upon execution by the at least one processing unit, causing the device to perform the steps of the method of the first aspect.

In a third aspect of the present disclosure, a non-transitory computer-readable storage medium is provided. The non-transitory computer-readable storage medium has a computer program stored thereon which, upon execution by an electronic device, causes the device to perform actions comprising: displaying a post interface of a media content; displaying a set of candidate tags in the post interface, the set of candidate tags being determined based on post information inputted through the post interface; and based on a selection of a target tag among the set of candidate tags, determining a target element corresponding to the selected target tag, the target element being configured to be displayed in a review page of the posted media content.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIGS. 2A-2B illustrate example interfaces in accordance with some embodiments of the present disclosure;

FIG. 3 illustrates a flow chart of an interaction process in accordance with some embodiments of the present disclosure;

FIG. 4 illustrates a block diagram of an apparatus for interaction in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

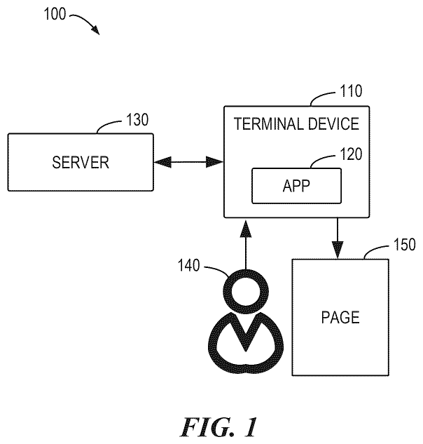

FIG. 1 illustrates a schematic diagram of an example environment 100 in which embodiments of the present disclosure can be implemented. In the example environment 100 of FIG. 1, an application 120 is installed in the terminal device 110. A user 140 may interact with the application 120 via the terminal device 110 and/or an attached device of the terminal device 110.

In some embodiments, the application 120 may be a content sharing application (e.g., a video application that focuses on video sharing), which is capable of providing various types of services to user 140, such as media content posting service.

In the example environment 100 of FIG. 1, if the application 120 is active, the terminal device 110 may present a page 150 of the application 120. The page 150 may include various types of pages that the application 120 can provide.

In some embodiments, the terminal device 110 communicates with a server 130 to enable provisioning of services to the application 120. The terminal device 110 may be any type of mobile terminal, fixed terminal, or portable terminal, including a mobile phone, a desktop computer, a laptop, a notebook, a netbook, a tablet, a media computer, a multimedia tablet, a personal communication system (PCS) device, a personal navigation device, a personal digital assistant (PDA), an audio/video player, a digital camera/video camera, positioning device, television receiver, radio broadcast receiver, e-book device, gaming device, or any combination of the foregoing, including accessories and peripherals for these devices or any combination thereof. In some embodiments, the terminal device 110 can also support any type of user-specific interface (such as “wearable” circuitry). The server 130 can be various types of computing systems/servers capable of providing computing capability, including but not limited to, a mainframe, an edge computing node, a computing device in cloud environment, and the like.

It should be understood that the structure and function of each element in the environment 100 is described for illustrative purposes only and does not imply any limitations on the scope of the present disclosure.

As discussed, adding a tag to a content item to be posted may enhance user navigation and content retrieval within platforms. Traditionally, a user need to manually input the tags, and therefore the efficiency of the posting media content may be affected and the quality of the tags may be not good enough.

According to embodiments of the present disclosure, an improved solution for interaction is proposed. According to the solution of embodiments of the present disclosure, a post interface of a media content may be displayed and a set of candidate tags can be provided in the post interface, wherein the set of candidate tags are determined based on post information inputted through the post interface. Further, based on a selection of a target tag among the set of candidate tags, determining a target element corresponding to the selected target tag, the target element being configured to be displayed in a review page of the posted media content.

In this way, the embodiments of the present disclosure may provide a set of tags that matches post information, thereby improving the efficiency for adding a tag to the media content. As such, a more accurate tag may be added to the media content, thereby improving the quality of posted media content.

It should be noted that all information related to the media content discussed herein are obtained and used after obtaining an associated user's permission.

Some example embodiments of the present disclosure will continue to be described below with reference to the accompanying drawings.

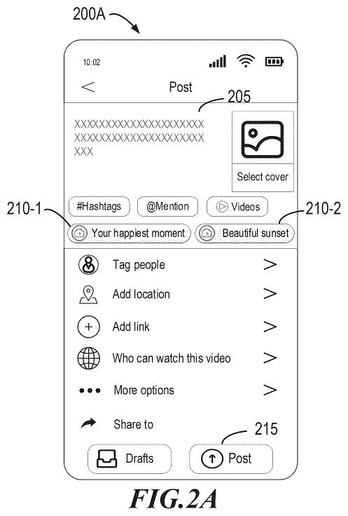

FIGS. 2A-2B illustrate example interfaces 200A and 200B in accordance with some embodiments of the present disclosure. The interface 200A and 200B may be displayed by the terminal device 110 as shown in FIG. 1.

As shown in FIG. 2A, the terminal device may display a post interface 200A in response to a post request for a media content. The media content may comprise and are not limited to a video, an image or an image collection.

In some embodiments, the post interface 200A may provide a set of controls for obtaining the post information for the media content. For example, the post interface may comprise an input control for obtaining the description text 205 for the media content. Such description text 205 may for example be the title for the posted media content.

In some further embodiments, the post information may also for example comprise location information, a visibility setting, tag information and so on.

In some embodiments, as shown in FIG. 2A, the terminal device 110 may provide a set of candidate tags in the post interface, for example, a candidate tag 210-1 and a candidate tag 210-2 (individually or collectively referred to as candidate tag 210).

In some embodiments, the candidate tag 210 may be determined based on the posted media content. Alternatively, the candidate tag 210 may be determined based on the post information received in the post interface 200A. For example, the candidate tag 210 may be determined based on the input description text 205.

The detailed process for determining the candidate tag 210 will be described in detail later.

In some embodiments, the terminal device 110 may receive a user's selection of at least one target tag among the set of candidate tags 210. For example, the terminal device 110 may receive the user's click on the tag 210-1.

The terminal device 110 may for example adjust a display style of the selected tag 210-1, for indicating that the tag 210-1 is added. As will be discussed, based on the selection of the tag 210-1, a target element corresponding to the selected tag 210-1 can be determined and the determined target element can be configured to be displayed in a review page of the posted media content.

In some embodiments, the terminal device 110 may receive a preset operation in the post interface 200A, and may display a preview page 200B of the posted media content as shown in FIG. 2B accordingly.

As shown in FIG. 2B, the terminal device 110 may display a target element 220 corresponding to the selected target tag (e.g., the tag 210-1) in the review page 200B of the posted media content.

In some embodiments, the target element 220 may comprise any proper types of interface element, for example, a sticker element. As shown in FIG. 2B, the target element may show the text content of the added tag 210-1.

In some embodiments, the terminal device 110 may receive a user's edition operation on the target element 220, and may determine a display style of the target element 220 based on the edition operation. For example, the user may adjust a size of the target element, may adjust a location of the target element 220 in the preview page, or may adjust a font of the text shown in the target element 220.

In some embodiments, the terminal device 110 may receive a post request of the user. For example, the terminal device 110 may receive the user's trigger of the post button 215 shown in FIG. 2A or the post button 225 shown in FIG. 2B.

Further, the terminal device 110 may trigger posting the media content. Further the terminal device 110 may display a review page of the posted media content, and may display a target element corresponding to the selected tag 210-1 in the review page.

For example, the review page of the posted media content may be similar to the preview page 200B. Further, the display style of the target element 220 in the review page may be determined based on the edition operation of the user in the preview page 200B.

For example, a size and/or a location of the target element 220 in the review page may be same as the preview page 200B.

Further, a selection of the target element displayed in the review page of the posted media content may be trigger display a preset page for review a set of media contents with the same tag 210-1.

The process of determining the set of candidate tags will be described now. In some embodiments, the server 130 as shown in FIG. 1 may determine a target feature associated with the media content.

In some further embodiments, the server 130 may also determine a feature of the post information. For example, the server 130 may receive the description text 205, and may generate the feature of the post information using a text encoder.

The target feature of the media content may comprise the feature of the post information. Further, the server 130 may determine the set of candidate tags 210 from a plurality of preset tags based on the target feature.

In some embodiments, the server 130 may first obtain at least one reference media content and may generating description information of the at least one reference media content using a first model.

For example, the server 130 may obtain a set of posted reference media contents and may using a generative model to generate the description information of the set of posted reference media contents. For example, the generative model may comprise a language model, and the description information may comprise a text content generated by the language model for describing the content of the posted reference media content.

Further, the server 130 may provide the description information to a second model, to generate at least one tag corresponding to the at least one reference media content. The second model may be same as the first model or different from the first model.

For example, the second model may comprise a generative model, e.g., a language model. The server 130 may provide the generated description information to the second model and may instruct the second model to generate at least one tag based on the description information.

Further, the server 130 may construct the plurality of preset tags based on the generated at least one tag corresponding to the at least one reference media content.

In some further embodiments, the plurality of preset tags may also comprise a tag input by users in the platform. For example, if usage information of a particular tag satisfies a preset condition, the particular tag may be added as a preset tag.

In some embodiments, the server 130 may determine similarity information between reference features of the plurality of preset tags and target feature. For example, the server 130 may determine the similarity information based on the vector difference or vector similarity between a first vector corresponding to the target feature and a second vector corresponding to a reference feature.

Further, the server 130 may determine the set of candidate tags from a plurality of preset tags based on the similarity information. For example, the server 130 may select a predetermined number of tags with top similarities from the plurality of preset tags.

Further, the server 130 may provide the determined candidate tags to the terminal device 130 for displaying. In some embodiments, the set of candidate tags 210 may be ranked in the post interface 200A based on at least one of usage information of the set of candidate tags. Additionally or alternatively, the ranking may also be determined matching information (e.g., the similarity) between the set of candidate tags and the media content.

In this way, the embodiments of the present disclosure may provide a set of tags that matches post information, thereby improving the efficiency for adding a tag to the media content. As such, a more accurate tag may be added to the media content, thereby improving the quality of posted media content.

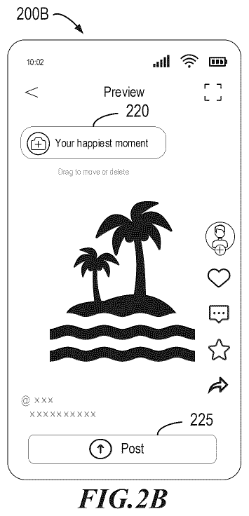

FIG. 3 illustrates a flow chart of an interaction process 300 in accordance with some embodiments of the present disclosure. The process 300 can be implemented at the terminal device 110 as shown in FIG. 1.

As shown in FIG. 3, at block 310, the terminal device 110 displays a post interface of a media content.

At block 320, the terminal device 110 displays a set of candidate tags in the post interface, the set of candidate tags being determined based on post information inputted through the post interface.

At block 330, the terminal device 110, based on a selection of a target tag among the set of candidate tags, determines a target element corresponding to the selected target tag, the target element being configured to be displayed in a review page of the posted media content.

In some embodiments, the process 300 further comprises: in response to receiving a preset operation in the post interface, displaying a preview interface of the media content; and displaying the target element corresponding to the selected target tag in the preview interface.

In some embodiments, a display style of the target element in the review page is determined based on an edition operation on the target element received in the preview interface.

In some embodiments, the set of candidate tags are determined through: determining a target feature associated with the media content, the target feature comprising a first feature of a second feature of the post information; and determining the set of candidate tags from a plurality of preset tags based on the target feature.

In some embodiments, the process 300 further comprises: obtaining at least one reference media content; generating description information of the at least one reference media content using a first model; providing the description information to a second model, to generate at least one tag corresponding to the at least one reference media content; and constructing the plurality of preset tags based on the at least one tag corresponding to the at least one reference media content.

In some embodiments, determining the set of candidate tags from a plurality of preset tags based on the target feature comprises: determining similarity information between reference features of the plurality of preset tags and target feature; and determining the set of candidate tags from a plurality of preset tags based on the similarity information.

In some embodiments, the set of candidate tags are ranked in the post interface based on at least one of: usage information of the set of candidate tags; matching information between the set of candidate tags and the media content.

In some embodiments, the post information comprises a description text of the media content input through the post interface.

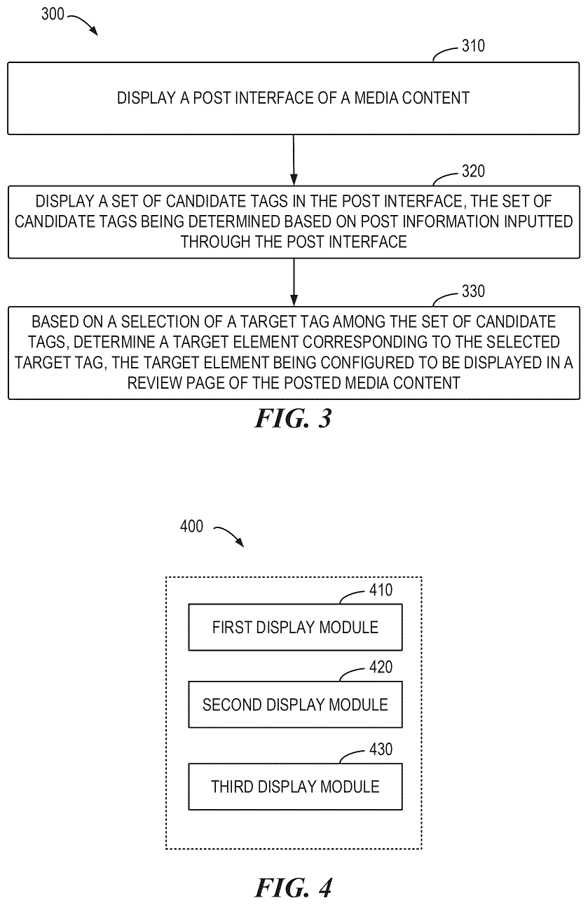

FIG. 4 shows a block diagram of an apparatus 400 for interaction in accordance with some embodiments of the present disclosure. The apparatus 400 may be implemented, for example, or included at the terminal device 110 of FIG. 1. Various modules/components in the apparatus 400 may be implemented by hardware, software, firmware, or any combination thereof.

As shown, the apparatus 400 comprises a first display module 410, configured for displaying a post interface of a media content; a second display module 420, configured for displaying a set of candidate tags in the post interface, the set of candidate tags being determined based on post information inputted through the post interface; and a third display module 430, configured for, based on a selection of a target tag among the set of candidate tags, determining a target element corresponding to the selected target tag, the target element being configured to be displayed in a review page of the posted media content.

In some embodiments, the first display module 410 is further configure for: in response to receiving a preset operation in the post interface, displaying a preview interface of the media content; and displaying the target element corresponding to the selected target tag in the preview interface.

In some embodiments, a display style of the target element in the review page is determined based on an edition operation on the target element received in the preview interface.

In some embodiments, the set of candidate tags are determined through: determining a target feature associated with the media content, the target feature comprising a feature of the post information; and determining the set of candidate tags from a plurality of preset tags based on the target feature.

In some embodiments, the apparatus 400 further comprises a generation module, configured for: obtaining at least one reference media content; generating description information of the at least one reference media content using a first model; providing the description information to a second model, to generate at least one tag corresponding to the at least one reference media content; and constructing the plurality of preset tags based on the at least one tag corresponding to the at least one reference media content.

In some embodiments, the apparatus 400 further comprises a determination module, configured for: determining similarity information between reference features of the plurality of preset tags and target feature; and determining the set of candidate tags from a plurality of preset tags based on the similarity information.

In some embodiments, the set of candidate tags are ranked in the post interface based on at least one of: usage information of the set of candidate tags; matching information between the set of candidate tags and the media content.

In some embodiments, the post information comprises a description text of the media content input through the post interface.

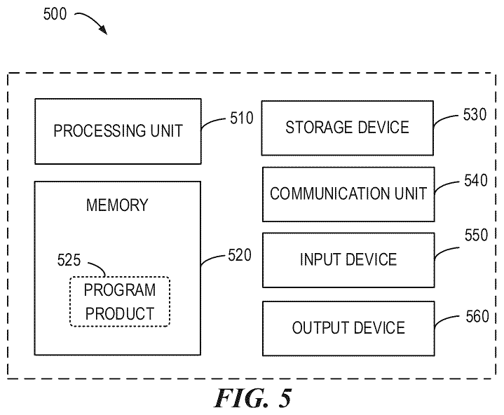

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the terminal device 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. An interaction method, comprising:
displaying a post interface of a media content;
displaying a set of candidate tags in the post interface, the set of candidate tags being determined based on post information inputted through the post interface; and
based on a selection of a target tag among the set of candidate tags, determining a target element corresponding to the selected target tag, the target element being configured to be displayed in a review page of the posted media content.

2. The method of claim 1, further comprising:
in response to receiving a preset operation in the post interface, displaying a preview interface of the media content; and
displaying the target element corresponding to the selected target tag in the preview interface.

3. The method of claim 2, wherein a display style of the target element in the review page is determined based on an edition operation on the target element received in the preview interface.

4. The method of claim 1, wherein the set of candidate tags are determined through:
determining a target feature associated with the media content, the target feature comprising a feature of the post information; and
determining the set of candidate tags from a plurality of preset tags based on the target feature.

5. The method of claim 4, further comprising:
obtaining at least one reference media content;
generating description information of the at least one reference media content using a first model;
providing the description information to a second model, to generate at least one tag corresponding to the at least one reference media content; and
constructing the plurality of preset tags based on the at least one tag corresponding to the at least one reference media content.

6. The method of claim 4, wherein determining the set of candidate tags from a plurality of preset tags based on the target feature comprises:
determining similarity information between reference features of the plurality of preset tags and target feature; and
determining the set of candidate tags from a plurality of preset tags based on the similarity information.

7. The method of claim 1, wherein the set of candidate tags are ranked in the post interface based on at least one of:
usage information of the set of candidate tags;
matching information between the set of candidate tags and the media content.

8. The method of claim 1, wherein the post information comprises a description text of the media content input through the post interface.

9. An electronic device, comprising:
at least one processing unit; and
at least one memory coupled to the at least one processing unit and storing instructions executable by the at least one processing unit, the instructions, upon execution by the at least one processing unit, causing the electronic device to perform actions comprising:
displaying a post interface of a media content;
displaying a set of candidate tags in the post interface, the set of candidate tags being determined based on post information inputted through the post interface; and
based on a selection of a target tag among the set of candidate tags, determining a target element corresponding to the selected target tag, the target element being configured to be displayed in a review page of the posted media content.

10. The electronic device of claim 9, the actions further comprising:
in response to receiving a preset operation in the post interface, displaying a preview interface of the media content; and
displaying the target element corresponding to the selected target tag in the preview interface.

11. The electronic device of claim 10, wherein a display style of the target element in the review page is determined based on an edition operation on the target element received in the preview interface.

12. The electronic device of claim 9, wherein the set of candidate tags are determined through:
determining a target feature associated with the media content, the target feature comprising a feature of the post information; and
determining the set of candidate tags from a plurality of preset tags based on the target feature.

13. The electronic device of claim 12, the actions further comprising:
obtaining at least one reference media content;
generating description information of the at least one reference media content using a first model;
providing the description information to a second model, to generate at least one tag corresponding to the at least one reference media content; and
constructing the plurality of preset tags based on the at least one tag corresponding to the at least one reference media content.

14. The electronic device of claim 12, wherein determining the set of candidate tags from a plurality of preset tags based on the target feature comprises:
determining similarity information between reference features of the plurality of preset tags and target feature; and
determining the set of candidate tags from a plurality of preset tags based on the similarity information.

15. The electronic device of claim 9, wherein the set of candidate tags are ranked in the post interface based on at least one of:
usage information of the set of candidate tags;
matching information between the set of candidate tags and the media content.

16. The electronic device of claim 9, wherein the post information comprises a description text of the media content input through the post interface.

17. A non-transitory computer-readable storage medium, having a computer program stored thereon which, upon execution by an electronic device, causes the device to perform actions comprising:
displaying a post interface of a media content;
displaying a set of candidate tags in the post interface, the set of candidate tags being determined based on post information inputted through the post interface; and
based on a selection of a target tag among the set of candidate tags, determining a target element corresponding to the selected target tag, the target element being configured to be displayed in a review page of the posted media content.

18. The non-transitory computer-readable storage medium of claim 17, the actions further comprising:
in response to receiving a preset operation in the post interface, displaying a preview interface of the media content; and
displaying the target element corresponding to the selected target tag in the preview interface.

19. The non-transitory computer-readable storage medium of claim 18, wherein a display style of the target element in the review page is determined based on an edition operation on the target element received in the preview interface.

20. The non-transitory computer-readable storage medium of claim 17, wherein the set of candidate tags are determined through:
determining a target feature associated with the media content, the target feature comprising a feature of the post information; and
determining the set of candidate tags from a plurality of preset tags based on the target feature.
